(19) United States
(12) Patent Application Publication
(10) Pub. No.: US 2011/0161225 A1
(43) Pub. Date: Jun. 30, 2011

(54) METHOD AND SYSTEM FOR PROCESSING LOAN APPLICATIONS IN A FINANCIAL INSTITUTION

(75) Inventor: Gaurav Nanda, Hazaribagh (IN)

(73) Assignee: INFOSYS TECHNOLOGIES LIMITED, Bangalore (IN)

(21) Appl. No.: 12/813,794

(22) Filed: Jun. 11, 2010

(30) Foreign Application Priority Data
Dec. 30, 2009 (IN) 3238/CHE/2009

(51) Int. Cl. G06Q 40/00

(52) U.S. Cl. 705/38

(57) ABSTRACT

A method and system for processing loan applications in a financial institution is provided. The method includes a step of receiving a first loan application from a first loan applicant. The first loan application includes personal information of the first loan applicant. Further, the method includes the step of determining a repayment score for the first loan applicant based on the personal information of the first loan applicant. The repayment score is calculated using a polynomial equation. The polynomial equation represents a relationship between personal information of a plurality of past loan applications and a plurality of past repayment scores. Furthermore, the method includes processing the first loan application based on a threshold set for repayment scores for a particular type of loan.

### FIELD OF THE INVENTION

The present invention relates, generally, to the field of loan processing systems, and in particular, to a unique method and system for processing loan applications in a financial institution.

### BACKGROUND OF THE INVENTION

In financial institutions loan applications are processed by receiving information from the loan applicant in the form of a form (electronic or paper). The loan applicant attaches details that include his personal information and his sources of income to the form while handing it over to the financial institution. The financial institution may receive this information directly from the applicant either electronically or manually, or through an agent of the financial institution.

Traditionally, decisions to grant loans to loan applicants have been taken by loan officers of the financial institution. The loan officers analyze the form submitted by the loan applicant, manually determine the ability of the applicant to repay the loan and decide whether to grant the loan or not. This method, however, is perception based and a fixed rule is not used across the financial institution to grant loans. Perception leads to errors in judgments and may lead to numerous defaulted loan cases.

With the advent of technology, loan processing systems have been automated with the help of rule based engines. Business rules are set by administrators of the financial institution and configured based on ideal conditions required for the loan application to be granted. In most practical scenarios, the actual personal information does not allow the rule based engines to approve loan applications. Hence, manual intervention is required to approve loan applications with a little deviation from the ideal conditions.

Complex rules based system can be built to cover many segments of applicants. However, configuring the rules engine for a new applicant segment is a tedious process involving manual intervention.

These and other problems in the existing systems in the art need to be addressed by a method and system that treats the loan processing systems in a bank, systematically. Hence, there is a need for a method and a system that establishes a relationship between past application data of the financial institution and the new applications received by the financial institution. Further, the method and system also needs to provide for functionalities to easily refine the relationship between past application data and the new applications on a periodic basis without manual intervention.

### SUMMARY OF THE INVENTION

In one embodiment of the present invention, a method for processing loan applications in a financial institution is provided. The method includes a step of receiving a first loan application from a first loan applicant. The first loan application includes personal information of the first loan applicant. Further, the method includes the step of determining a repayment score for the first loan applicant based on the personal information of the first loan applicant. The repayment score is calculated using a polynomial equation. The polynomial equation represents a relationship between personal information of a plurality of past loan applications and a plurality of past repayment scores. Furthermore, the method includes processing the first loan application based on a threshold set for repayment scores for a particular type of loan.

In another embodiment of the present invention, a system for processing loan applications in a financial institution is provided. The system comprises a user interface to receive a first loan application from a first loan applicant. The first loan application includes personal information of the first loan applicant. The system further comprises a processor that is configured to determine a repayment score for the first loan applicant based on the personal information of the first loan applicant. The repayment score is calculated using a polynomial equation that represents a relationship between a plurality of past loan applications and a plurality of past repayment scores. Furthermore, the processor is configured to process the first loan application based on a threshold set for repayment score for a particular type of loan.

### BRIEF DESCRIPTION OF DRAWINGS

These and other features, aspects, and advantages of the present invention will be better understood when the following detailed description is read with reference to the accompanying drawings in which like characters represent like parts throughout the drawings, wherein:

FIG. 1 is a block diagram illustrating conventional ways of processing loan applications;

FIG. 2 illustrates a method for processing loan applications in a financial institution, in accordance with an embodiment of the present invention; and

FIG. 3 illustrates a system for processing loan applications in a financial institution, in accordance with an embodiment of the present invention.

### DETAILED DESCRIPTION OF THE INVENTION

The following description is the full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof, since the present technique is defined solely by the claims.

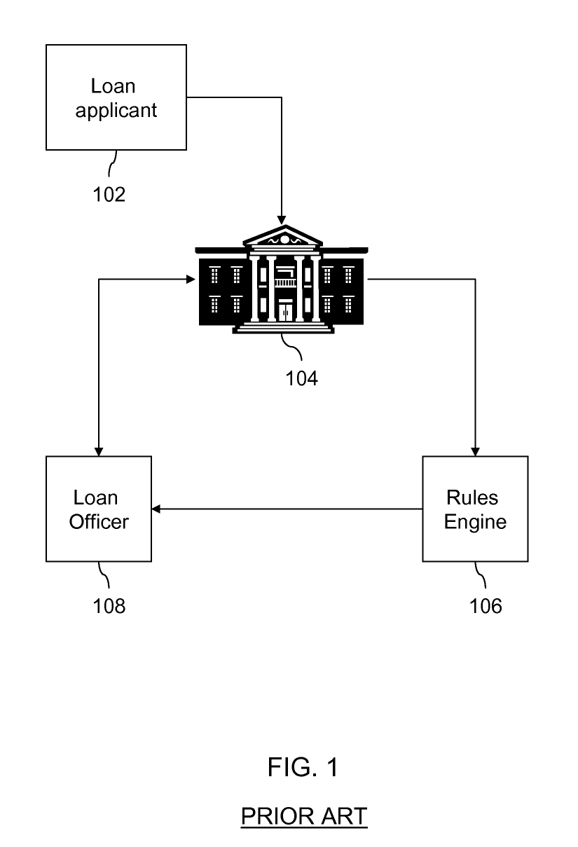

Financial institutions such as banks and lending agencies are on a constant look out for people who are in need of money to fulfill their needs. To help people acquire assets or fulfill their needs, financial institutions offer loans of various types. Loans offered by various financial institutions include, but are not limited to, home loans, car loans, personal loans, educational loans, and medical loans. A process to process and grant loans to applicants is followed in every financial institution. FIG. 1 illustrates a conventional way of processing loan applications in financial institutions. A loan applicant 102 submits his loan application to the financial institution 104 through various means. Various means of submitting the loan application include filling a paper based form, submitting an online form, and contacting an agent. The loan application includes personal information of the loan applicant. Personal information of the loan applicant includes, but is not limited to, name, address, information about sources of income, and assets and liabilities of the applicant. The financial institution can process the loan application in multiple ways; it can either send the application to be processed by a rules engine 106 or the application can be sent to a loan officer 108 for decision making. In some cases, the rules engine 106 makes an initial decision based on personal information of the applicant and forwards the application to the loan officer 108 who then decides to grant or reject the loan. These methods however involve high level of human intervention and even the rules engine 106 needs to be re-configured to factor in new data that the financial institution receives every day.

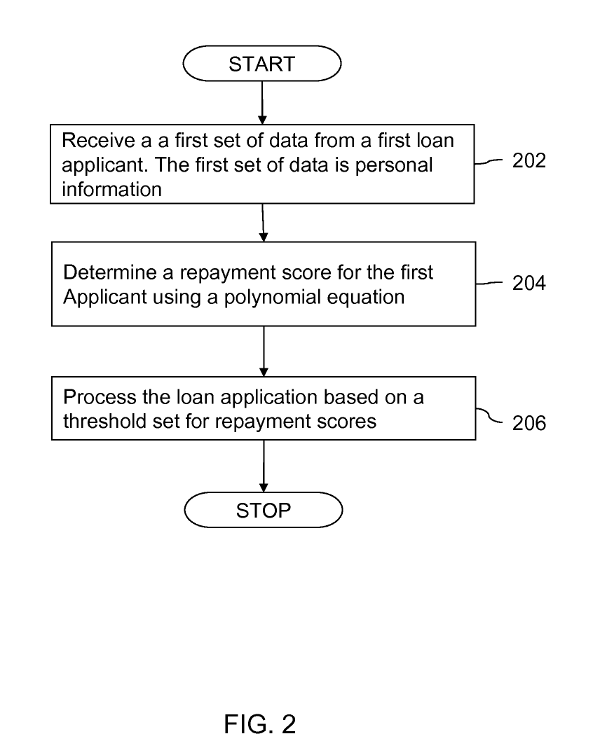

FIG. 2 illustrates a method to process loan applications in a financial institution, according to one embodiment of the present invention. The method includes step 202 of receiving a first loan application for a first loan applicant. The first loan application includes personal information of the first loan applicant. Further, at step 204, a repayment score is determined for the first loan applicant based on the personal information of the first loan applicant. The repayment score is calculated using a polynomial equation that represents a relationship between a plurality of past loan applications and a plurality of past repayment scores. At step 206, based on a threshold set for repayment scores for different types of loan, the first loan application is processed.

According to one embodiment of the present invention, the plurality of past repayment scores are decided based on a repayment history of each of the plurality of past loan applications. An administrator of the financial institution analyzes repayment trend of each loan application from the plurality of past loan applications. Based on the duration in which the loan was closed or whether the loan was closed or no, the administrator assigns a repayment score to each of the plurality of past loan applications. The plurality of the past repayment scores are representative of a risk involved in granting loan to a particular profile of a loan applicant.

The plurality of past repayment scores are further used in the polynomial equation, along with personal information in the plurality of past loan applications, to establish a relationship between personal information and repayment scores. According to one embodiment of the present invention, the polynomial equation that represents the relationship between personal information and repayment scores can be as follows:

y=ax₁ⁿ^{₁}+bx₂ⁿ^{₂}+cx₃ⁿ^{₃}+dx₄ⁿ^{₄}+ . . . (1)

In Eq. (1) y is repayment score for a loan application and xᵢ to x₄ represent personal information from a loan application.

According to another embodiment of the present invention, the administrator of the financial institution selects a set of values for a set of coefficients (a, b, c, d . . . ) and a degree (n) of the polynomial equation (1). According to another embodiment of the present invention, a random number generation module is used to select a set of values for the set of coefficients and the degree of Eq. (1). Further, personal information from the plurality of past loan applications and the set of values are fed into Eq. (1) to calculate a plurality of automated repayment scores for each of the plurality of past loan applications. Furthermore, the plurality of automated repayment scores and the plurality of past repayment scores, set by the administrator, are subtracted to calculate an error. If the error between the automated repayment scores and the past repayment scores is above a certain threshold, a new set of values for the set of coefficients and the degree of the polynomial equation is selected. The earlier process of calculating the error is then performed cyclically until the error between the plurality of automated repayment scores and the plurality of past repayment scores is below the threshold. The set of values that lead to error below the threshold is fed to the polynomial equation (1). Eq. (1) with the set of values and personal information from the first loan application are used to calculate the repayment score for the first loan applicant. Based on the repayment score of the first loan applicant, the first loan application is processed.

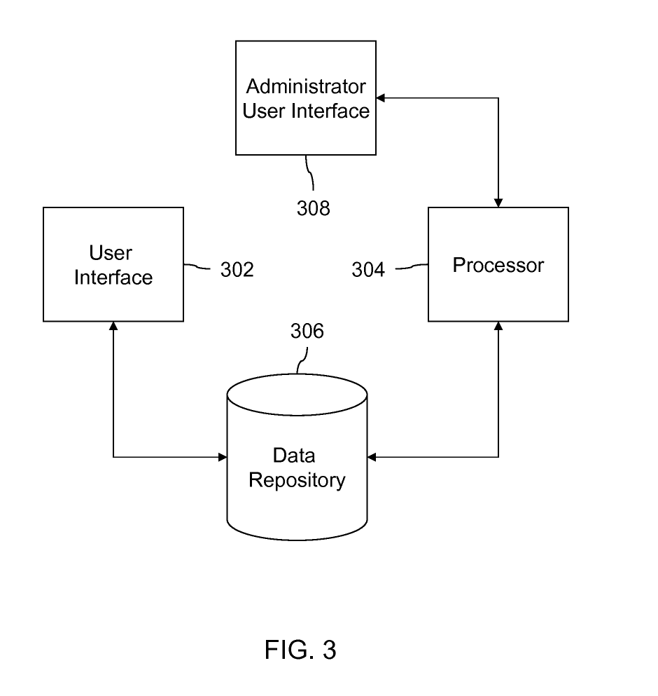

FIG. 3 illustrates a system for processing loan applications in a financial institution, according to one embodiment of the present invention. The system includes a user interface 302, a processor 304, data repository 306, and an administrator user interface 308. The user interface 302 is configured to receive a first loan application from a first loan applicant. The first loan application includes personal information of the loan applicant. The processor 304 is configured to determine a repayment score for the first loan applicant using personal information of the first loan applicant. The repayment score is calculated using a polynomial equation that represents a relationship between a plurality of past repayment scores and a plurality of past loan applications. Furthermore, the process 304 is configured to process the first loan application based on a threshold set for a particular type of loan.

According to one embodiment of the present invention, the data repository 306 stores personal information of the plurality of past loan applications. An administrator of the financial institution uses the administrator user interface 308 to set the plurality of past repayment scores for each of the plurality of past loan applications. The plurality of past repayment scores are set based on a duration taken to close the loan or whether the loan was closed or no. Further, the plurality of past repayment scores are stored in the data repository 306 corresponding to each of the plurality of loan applications. According to one embodiment of the present invention, the polynomial equation that represents the relationship between personal information and repayment scores has been expressed as Eq. (1) in conjunction with description of FIG. 2.

In Eq. (1) y is repayment score for a loan application and x₁ to x₄ represent personal information from a loan application. According to another embodiment of the present invention, the administrator of the financial institution uses the administrator user interface 308 to select a set of values for a set of coefficients (a, b, c, d . . . ) and a degree (n) of the polynomial equation (1). According to another embodiment of the present invention, a random number generation module is used to select a set of values for the set of coefficients and the degree of Eq. (1). Further, the processor 304 reads personal information of the plurality of past loan applications from the data repository 306 and uses the set of values in Eq. (1) to calculate a plurality of automated repayment scores for each of the plurality of past loan applications.

Furthermore, the processor 304 calculates an error between the plurality of automated repayment scores and the plurality of past repayment scores. If the processor 304 communicates to the administrator via the administrator user interface 308 that the error between the automated repayment scores and the past repayment scores is above a certain threshold, a new set of values for the set of coefficients and the degree of the polynomial equation is selected using the administrator user interface 308. The processor 304 then calculates the error cyclically until the error between the plurality of automated repayment scores and the plurality of past repayment scores is below the threshold. The set of values that lead to error below the threshold is fed to the polynomial equation (1). Eq. (1) with the set of values and personal information from the first loan application are used to calculate the repayment score for the first loan applicant. Based on the repayment score of the first loan applicant, the first loan application is processed.

As will be appreciated by those ordinary skilled in the art, the foregoing example, demonstrations and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

While the following description is presented to enable a person of ordinary skill in the art to make and use the invention and is provided in the context of the requirement for a obtaining a patent the present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest cope consistent with the principles and features described herein.

Many modifications of the present invention will be apparent to those skilled in the arts to which the present invention applies. Further, it may be desirable to use some of the features of the present invention without the corresponding use of other features.

Accordingly, the foregoing description of the present invention should be considered as merely illustrative of the principles of the present invention and not in limitation thereof.

What is claimed is:

1. A computer implemented method for processing loan applications in a financial institution, the method comprising:
Receiving a first loan application from a first loan applicant, wherein the first loan application comprises personal information of the first loan applicant;
determining a repayment score for the first loan applicant using a polynomial equation that represents a relation between a plurality of past repayment scores and personal information of the plurality of past loan applications, wherein the polynomial equation takes the personal information of the first loan applicant as an input; and
processing the first loan application based on a threshold set for repayment score for a particular type of loan.

2. The method as recited in claim 1, wherein the plurality of past repayment scores is decided based on a repayment history of the plurality of past loan applications, and wherein the repayment history comprises duration in which each of the plurality of past applications was closed.

3. The method as recited in claim 1, wherein past repayment score is an independent variable of the polynomial equation and personal information are dependent variables of the polynomial equation

4. The method as recited in claim 2 further comprises choosing a set of values for a set of coefficients and a degree of the polynomial equation.

5. The method as recited in claim 4 further comprises calculating a plurality of automated repayment scores for the plurality of past applications using the set of values and the personal information of the plurality of past loan applications.

6. The method as recited in claim 5 further comprises choosing a new set of values for the set of coefficients and the degree of the polynomial equation based on an error between the plurality of automated repayment scores and plurality of past repayment scores.

7. The method as recited in claim 6 further comprises using the new set of values and the personal information of the first loan applicant to calculate the repayment score for the first loan applicant.

8. A system for processing loan applications in a financial institution, the system comprising:
a user interface for receiving a first loan application from a first loan applicant, wherein the first loan application comprises personal information of the first loan applicant; and
a processor configured to:
determine a repayment score for the first loan applicant using a polynomial equation that represents a relation between a plurality of past repayment scores and personal information of the plurality of past loan applications, wherein the polynomial equation takes the first loan application as an input; and
process the first loan application based on a threshold set for repayment score for a particular type of loan.

9. The system as recited in claim 8 further comprises a data repository, wherein the data repository stores personal information of the plurality of past loan application

10. The system as recited in claim 8 further comprises an administrator user interface to decide the plurality of past repayment scores, wherein the plurality of past repayment scores are decided based on duration in which each of the plurality of past loan applications was closed.

11. The system as recited in claim 10 wherein the administrator user interface is further used to feed a set of values corresponding to a set of coefficients and a degree of the polynomial equation.

12. The system as recited in claim 11 wherein a random number generator module is used to generate the set of values corresponding to the set of coefficients and the degree of the polynomial equation.

13. The system as recited in claim 11, wherein the processor is further configured to:
calculate a plurality of automated repayment scores using the set of values and personal information of the plurality of past loan applications in the polynomial equation; and
determine an error between the plurality of automated repayment scores and the plurality of past repayment scores.

14. A computer program product for processing loan applications in a financial institution, the computer program product comprising instructions configured to:
receive a first loan application from a first loan applicant, wherein the first loan application comprises personal information of the first loan applicant;
determine a repayment score for the first loan applicant using a polynomial equation that represents a relation between a plurality of past repayment scores and personal information of the plurality of past loan applications, wherein the polynomial equation takes the first loan application as an input; and
process the first loan application based on a threshold set for repayment score for a particular type of loan.

15. The computer program product as recited in claim 14 further comprises program instructions configured to read from a data repository, personal information of the plurality of past loan application

16. The computer program product as recited in claim 14 further comprises program instructions configured to set the plurality of past repayment scores, wherein the plurality of past repayment scores are decided based on a duration in which each of the plurality of past loan applications was closed.

17. The computer program product as recited in claim 16 further comprises program instructions to receive a set of values corresponding to a set of coefficients and a degree of the polynomial equation that are fed by an administrator.

18. The computer program product as recited in claim 17 further comprises program instructions to generate random numbers to the set of values corresponding to the set of coefficients and the degree of the polynomial equation.

19. The computer program product as recited in claim 17 further comprises program instructions configured to:
calculate a plurality of automated repayment scores using the set of values and personal information of the plurality of past loan applications in the polynomial equation; and
determine an error between the plurality of automated repayment scores and the plurality of past repayment scores.
